(19) United States
(12) Patent Application Publication
(10) Pub. No.: US 2010/0249361 A1
(43) Pub. Date: Sep. 30, 2010

(54) PROCESS FOR PRODUCTION OF POLYESTER COPOLYMERS AND A COMPOSITION INCORPORATING THE COPOLYMERS

(76) Inventors: Shaofeng Wang, Singapore (SG); Bo Jing, Singapore (SG); Yuqiang Huang, Singapore (SG); Lianlong Hou, Singapore (SG); Siok Ling Sherlyn Yap, Singapore (SG)

Correspondence Address: OCCHIUTI ROHLICEK & TSAO, LLP, 10 FAWCETT STREET, CAMBRIDGE, MA, 02138, US

(21) Appl. No.: 12/682,459

(22) PCT Filed: Jul. 29, 2008
(86) PCT No.: PCT/SG08/00275

§ 371 Date: Jun. 18, 2010

Related U.S. Application Data
(60) Provisional application No. 60/979,197, filed on Oct. 11, 2007.

(51) Int. Cl. C08G 63/12; C08G 18/42; C08G 63/78

(52) U.S. Cl. 528/84; 528/272; 528/297; 528/302; 528/303

(57) ABSTRACT

There is disclosed a process for producing a polyester copolymer. The process comprises the step of condensating a hydroxyacid, a diol, a dicarboxylic acid and a functionalizing agent selected to form a prepolymer having a polyester copolymer backbone with arms comprising cross-linkable groups extending therefrom. The process also comprises the step of coupling said prepolymer in the presence of a coupling agent to cross link the arms of plural prepolymer backbones and thereby form said polyester copolymer comprising said plural straight chain polyester copolymers coupled to each other by said cross-linked arms. The polyester copolymer may be biodegradable and may be used as a modifier to increase the strength of polylactic acid.

### TECHNICAL FIELD

The present invention generally relates to a process for the production of polyester co-polymers. The present invention also relates to a composition which utilizes the co-polymers.

### BACKGROUND

Polylactic acid (PLA) is a highly useful material due to its chemical, mechanical and physical properties. In recent years, PLA has gained increasing economic importance due to its biodegradability as it can be degraded, under natural conditions, to carbon dioxide water and humus by microorganisms.

PLA has been woven into fibers using conventional melt-spinning processes. Spun-bound and melt-blown non-wovens fibers are also easily produced from PLA. PLA may be used in various applications such as household and industrial wipes, diapers, feminine hygiene products, disposable garments, and UV resistant fabrics. Furthermore, because polylactic acid is bioasborable and can be assimilated by a biological system, it can be readily used for implants in bone or soft tissue and for resorbable sutures.

To be useful in certain applications, such as in medical implants, clothing, vehicle bodies, computer bodies and other related components, the polyhydroxy acids must have sufficient mechanical strength. However, a problem with PLA is that its inherent strength is not very high. In particular, PLA tends to be brittle with a Notched Izod Impact strength around 15 J/m, which is much lower than conventional engineering plastics, such as polypropylene, polyethylene, polystyrene and Acrylonitrile, Butadiene, and Styrene (ABS) copolymer.

The relatively low impact strength of PLA restricts their possible use in wider applications, particularly where relatively strong materials are required.

On the other hand while materials such as synthetic rubber and polyurethane have relatively high strength, they are non-biodegradable polymers. Accordingly, if these materials are to be used as a modifier of PLA, while the modified PLA will have increased strength, it will not deteriorate as readily and therefore can not be considered to be biodegradable.

There is also a need to provide a process for producing a copolymer that overcomes, or at least ameliorates, one or more of the disadvantages described above.

There is also a need to provide a process for producing a copolymers that can be used in conjunction with PLA so that the strength of the PLA is improved, but which is biodegradable.

### SUMMARY

According to a first aspect, there is provided a process for producing a polyester copolymer, the process comprising the steps of:

condensating a hydroxyacid, a diol, a dicarboxylic acid and a functionalizing agent selected to form a prepolymer having a polyester copolymer backbone with arms comprising cross-linkable groups extending therefrom; and

coupling said prepolymer in the presence of a coupling agent to cross link the arms of plural prepolymer backbones and thereby form said polyester copolymer comprising said plural straight chain polyester copolymers coupled to each other by said cross-linked arms.

Advantageously, the polyester copolymer that is formed is a three-dimensional network of polyester copolymer chains comprising the plural straight chain polyester copolymers coupled to each other by the cross-linked arms. Advantageously, the polyester copolymer produced in the disclosed process has a higher viscosity relative to straight chain polyester copolymers. Advantageously, the impact strength of the polyester copolymer produced in the disclosed process has higher impact strength relative to low molecular weight polyester copolymers. More advantageously, in some embodiments, the polyester copolymer is biodegradable and has a higher impact strength relative to polylactic acid. Without being bound by theory, it is thought that the formed three-dimensional network of polyester copolymer chains provides increased material strength. Hence, embodiments of the disclosed process may be used for making biodegradable polyester copolymers that are stronger and can be a suitable replacement for, some known biodegradable polymers such as polylactic acid.

According to a second aspect, there is provided a melt processable polyester composition comprising:

a first phase comprising a polyhydroxy acid having molecular weight greater than 100,000; and

a second phase comprising at least one of:
i) a prepolymer formed by condensating a hydroxyacid, a diol, a dicarboxylic acid and a functionalizing agent selected to form a prepolymer having a polyester copolymer backbone with arms comprising cross-linkable groups extending therefrom; and
ii) a polyester copolymer made in the first aspect.

According to a third another aspect, there is provided a process for producing a copolymer of polyhydroxy acid and polyester, the process comprising the steps of:

mixing polyhydroxy acid, a reactive compatibilizer and at least one of:
I) a prepolymer formed from a condensated reaction of a hydroxy acid, a diol, a dicarboxylic acid and a functionalizing agent selected to form a polyester copolymer backbone with arms comprising cross-linkable groups extending therefrom; and
II) a copolymer polyester formed from coupling of said prepolymer (I) in the presence of a coupling agent to cross link the arms of plural prepolymer backbones and thereby form said polyester copolymer.

Advantageously the mixture of said polyhydroxy acid, said reactive compatibilizer and at least one of said prepolymer and copolymer polyester chemically react so that the arms of said plural prepolymer backbones cross-link and thereby form said copolymer of polyhydroxy acid and polyester comprising plural straight chain polyhydroxy acid and polyester copolymer coupled to each other by said cross-linked arms.

In one embodiment of the third aspect, the hydroxyacid of the condensating step is not a polyhydroxy acid.

In one embodiment of the third aspect the mixing of said polyester copolymer and said polyhydroxy acid, optionally with an additive is undertaken in a reactor such as a batch reactor or extruder. The reaction is preferably an extruder, more preferably a twin-screw extruder.

According to a fourth aspect, there is provided a melt processable composition comprising:

a high molecular weight polyhydroxy acid; and

a prepolymer having a polyester copolymer backbone with arms comprising cross-linkable groups extending therefrom.

According to a fifth aspect, there is provided a melt processable composition comprising:

a high molecular weight polyhydroxy acid; and

a polyester copolymer made in any one of the first or second aspects defined above.

### DEFINITIONS

The following words and terms used herein shall have the meaning indicated:

The term “biodegradable” in this specification means a polymer that is capable of being “degraded” in that it undergoes significant change in its chemical structure under specific environmental conditions over time, upon which exposure results in a loss of some properties of the polymer. Such specific environmental conditions may include exposure to naturally occurring microorganisms like bacteria, fungi, and algae. Depending on the additional components present in the composition and the dimensions of the object made from the biodegradable polymer, the time period required for a degradation will vary and may also be controlled when desired. Generally, the time span for biodegradation will be significantly shorter than the time span required for a degradation of objects made from conventional plastic materials having the same dimensions, such as for example polyethylene, which have been designed to last for as long as possible.

The term “prepolymer” in the context of this specification denotes a low molecular weight copolymer comprising monomers units that are further polymerizable. Typically, the molecular weight of said prepolymers is less than about 100,000, more typically between about 5,000 to about 100,000.

The term “high molecular weight” in the context of this specification means a polyester copolymer having a molecular weight of more than 100,000. In some embodiments, the high molecular weight of the polyhydroxy acid is about 100,000 to about 200,000.

The term “melt-processable” in the context of this specification means a polyester copolymer that is capable of being processed in its molten state using processes such as injection molding, extrusion, blow molding, and/or compression molding. Preferably, the melt processable polyester copolymer does not exhibit significant oxidative degradation, decomposition, or pyrolysis at the processing temperatures typically used in such molding processes.

The term “hydroxyacid” as used herein refers to acids having at least one alcoholic hydroxyl group and at least one carboxyl functional group, such as lactic acid, glycolic acid, malic acid, tartaric acid, citric acid, hydroacrylic acid, α-hydroxybutyric acid, glyceric acid, tartronic acid and like aliphatic hydroxycarboxylic acids.

The term “polyhydroxy acid” as used herein means polymer of repeating hydroxy acid monomer units. Exemplary polyhydroxy acids include polylactic acid. The term “polylactic acid” as used herein means polymers with at least 50% of their repeating monomer units are lactic acid.

The term “cross-linkable groups” in the context of this specification is employed herein in a broad sense and is intended to encompass, for example, functional groups and photo crosslinkable or thermally crosslinkable groups, which are well-known to a person skilled in the art. It is well known in the art that a pair of matching crosslinkable groups can form a covalent bond or linkage under known reaction conditions, such as, oxidation-reduction conditions, condensation conditions, addition conditions, substitution (or displacement) conditions, free radical polymerization conditions, 2+2 cyclo-addition conditions, Diels-Alder reaction conditions, ROMP (Ring Opening Metathesis Polymerization) conditions, vulcanization conditions, cationic crosslinking conditions, and epoxy hardening conditions. For example, a hydroxyl group is capable of being covalently bonded with a carboxyl group; or a carbon-carbon double bond is covalently bondable with another carbon-carbon double bond. Exemplary crosslinkable groups include hydroxyl, carboxylic acids, epoxy, ester-forming derivatives and unsaturated dicarboxylic acid groups.

The term “functionalizing agent” in the context of this specification is to be interpreted broadly to include any compound capable of reacting with condensating mixture of hydroxyacid, diol and dicarboxylic acid to form branch groups extending from a polyester copolymer backbone. Hence, the functionalizing agent may be selected from any one of the (two) categories thereof or mixtures thereof: (i) any compound functional groups, preferably three or more functional groups, where the functional groups include hydroxyl group, epoxy group, carboxylic acid or ester-forming derivative group thereof or mixtures thereof; and (ii) unsaturated dicarboxylic acid component selected from the group consisting of dicarboxylic acids, anhydrides thereof and esters thereof with a monohydric alcohol and wherein the ethylenically unsaturated polymerizable monomer has a —CH═CH₂— group.

Exemplary non-limitive examples of functionalizing agents include (i) pentaerythritol, dipentaerythritol, tripentaerythritol, glycerol, open and cyclic condensation products of glycerol (and/or other polyalcohols) such as diglycerols, triglycerols, tetraglycerols, pentaglycerols, and hexaglycerols; diglycidyl ether, diglycidyl-di-ether, ethylene glycol diglycidyl ether, glycerol diglycidyl ether, butanediol-diglycidyl ether, trimethylolpropane triglycidyl ether, 1,2,3-pentanetriol, 1,2,4-pentanetriol, 2,3,4-pentanetriol, 1,2,3-cyclopentanetriol, 1,2,3-hexanetriol, 1,2,4-hexanetriol, 1,2,3,4-hexanetetrol, 1,2,4-cyclohexanetriol, 1,2,5-cyclohexanetriol, 1,2,3,4-cyclohexanetetrol, 1,2,3,5-cyclohexanetetrol, inositol, citric acid (i.e., 2-hydroxy-1,2,3-propane tricarboxylic acid), thiodisuccinic acid, trans-1-propene-1,2,3-tricarboxylic acid, all cis-1,2,3,4-cyclopentanetetracarboxylic acid, alkyl-cycloalkyltricarboxylic acid, trimethyl-cyclohexanetricarboxylic acid and mixtures thereof; and (ii) maleic acid, fumaric acid, itaconic acid, citraconic acid and mixtures thereof.

The term “dicarboxylic acid” used herein refers to straight or branched chain monomers which have two carboxylic acid functionalities and also acid anhydrides. The term also refers to equivalents of dicarboxylic acids having two functional carboxyl groups whose behaviour is practically the same as that of the dicarboxylic acids in the conversion with diols to copolyesters. These equivalents include esters and ester forming derivatives, such as the acid halides and anhydrides. The requirements regarding the molecular weight relate to the acid and not to equivalent esters or ester forming derivatives thereof. The dicarboxylic acids may contain randomly substituted groups or combinations which do not detrimentally affect polyester formation or the use of the polymer. The term includes both aliphatic dicarboxylic acids and aromatic dicarboxylic acids. In embodiments where the polyester copolymer is to be biodegradable, then aliphatic dicarboxylic acids are used.

The term “aliphatic dicarboxylic acids” used herein, are carboxylic acids having two carboxylgroups which are each attached to a saturated carbon atom. Aliphatic or cycloaliphatic acids having conjugated unsaturation often cannot be used because of homopolymerization. However, some unsaturated acids, such as maleic acid, can be used. Exemplary aliphatic dicarboxylic acids are oxalic, malonic, succinic, glutaric, adipic, dodecanonic, any anhydrides such as succinic anhydride, adipic anhydride and the like.

The term “aromatic dicarboxylic acids” used herein are dicarboxylic acids having two carboxyl groups attached to a carbon atom in an isolated or fused benzene ring. It is not necessary that both functional carboxyl groups be attached to the same aromatic ring and where more than one ring is present, they can be joined by aliphatic or aromatic divalent radicals or divalent radicals such as —O— or —SO₂—.

The term “catalyst” is to be interpreted broadly to include any substance that increases the rate of polycondensation or polymerization of said polyester copolymers, without being substantially consumed in the reaction.

As used herein, the term “diol” refers to all monomers which have two alcohol functionalities thereon. In embodiments where the polyester copolymer is to be biodegradable, then aliphatic diols are used. Exemplary, non-limiting diols include saturated alkyl diols such as ethanediol, ethenediol, ethylene glycol, diethylene glycol, 1,2-propranadiol, 1-3-propanadiol (propylene glycol), neopentyl glycol, 1,3-propanediol, 1,2-propanediol, 2,3-propanediol, 1,4-butanediol, 1,3-butanediol, 1,2-butanediol, 2,4-butanediol, 2,3-butanediol, 3,4-butanediol, alkyl substituted diols such as 2-methyl-1,5-pentanediol and cycloalkane diols such as 1,4-cyclohexanedimethanol, 1,2-cyclohexanedimethanol, 1,4-cyclohexanediethanol, 1,6-hexanediol, polyalkyleneglycols such as polyethyleneglycols, polypropyleneglycols, ethylenepropyleneglycol, polyethylenepropylene glycols, ethylenepropylene glycol copolymers, and ethylenebutylene glycol copolymers, 1,4-cyclopentanedimethanol, 1,3-cyclopentanedimethanol, 1,1-cyclopropanediol, 1,2-cyclopropanediol, 1,1-cyclopropanedimethanol, 1,2-cyclopropanedimethanol, 1,1-cyclobutanediol, 1,2-cyclobutanediol, 1,3-cyclobutanediol, 1,2-cyclobutane dimethanol, 2-methyl-1,2-butanediol, 3-methyl-2,2-butanediol, 1,2-pentanediol, 1-3-pentanediol, 1,4-pentanediol, 2,3-pentanediol, 2,4-pentanediol, 1,1-cyclopentanediol, 1,2-cyclopentanediol, 1,3-cyclopentanediol, 1,2-hexanediol, 1,3-hexanediol, 1,1-cyclohexanediol, 1,2-cyclohexanediol, 1,4-cyclohexanediol.

The term “coupling”, and grammatical variations thereof, is to be interpreted broadly to include any process whereby monomer molecules reactively couple with each other, or with a polymer chain of polyester copolymer, in a chemical reaction to form larger molecular weight polymer chains of polyester copolymer. The coupling mechanism can be cationic, anionic, coordination or free radical polymerization.

The term “hydroxyl groups” describes the functional group —OH when it is a substituent in an organic compound.

The term “coupling agent” refers to any reagent capable of facilitating coupling between two or more prepolymers in a polymerization reaction.

The term “isocyanate coupling agent” refers to a reagent containing the functional group of atoms —N═C═O and capable of facilitating the formation of bonds between two polypeptides. The term “isocyanate coupling agent” includes mono isocyanates, diisocyanates and polyisocyanates. The term “diisocyanate” refers to any organic compound containing two isocyanate (—NC═O) groups. The term “polyisocyanate” refers to any organic compound containing three or more isocyanate (—N═C═O) groups. Exemplary diisocyanate and polyisocyanate compounds include aromatic polyisocyanates such as 2,4-tolylene diisocyanate, 2,6-tolylene diisocyanate, 4,4′-diphenylmethane diisocyanate, 2,4′-diphenylmethane diisocyanate, p-phenylene diisocyanate, and polymethylene polyphenylene polyisocyanate; aliphatic polyisocyanates such as hexamethylene diisocyanate (HMDI), and tetramethylxylylene diisocyanate (TMXDI); alicyclic polyisocyanates such as isophorone diisocyanate (IPDI); arylaliphatic polyisocyanates such as xylylene diisocyanate; and the polyisocyanate as mentioned above modified with carbodiimide or isocyanurate; which may be used either alone or in combination of two or more. Exemplary commercially available polyisocyanates are CORONATE HX™ of and CORONATE HXR™, both of Nippon Polyurethene Ind. Co. Ltd.

The term “polymerization conditions” and grammatical variations thereof is defined herein to mean conditions, such as temperature and pressure, which are sufficient to promote polymerization of the polyhydroxy acid.

The term “reaction zone” is to be interpreted broadly to include any region or space in which a dehydration condensation reaction of monomeric mixture occurs to form polyester copolymers described herein. Hence, the term may refer to a single enclosed region such as a reaction chamber of a reactor it may refer to plural enclosed regions of a reaction chamber of plural reactors.

Unless specified otherwise, the terms “comprising” and “comprise”, and grammatical variants thereof, are intended to represent “open” or “inclusive” language such that they include recited elements but also permit inclusion of additional, unrecited elements.

As used herein, the term “about”, in the context of concentrations of components of the formulations, typically means +/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

### DISCLOSURE OF EMBODIMENTS

Exemplary, non-limiting embodiments of a process for producing a polyester copolymer and a melt-processable polymer composition will now be disclosed. The process resides in the step of condensating a hydroxyacid, a diol, a dicarboxylic acid and a functionalizing agent selected to form a prepolymer having a polyester copolymer backbone with arms comprising cross-linkable groups extending therefrom. The process also resides in the step of coupling said prepolymer in the presence of a coupling agent to cross link the arms of plural prepolymer backbones and thereby form said polyester copolymer comprising said plural straight chain polyester copolymers coupled to each other by said cross-linked arms.

Also disclosed is a melt processable composition comprising high molecular weight polyhydroxy acid and the polyester copolymer. The melt processable composition can be processed to form a copolymer of polyester and polyhydroxy acid.

To produce a biodegradable polyester copolymer, an hydroxyacid, an aliphatic diol and an aliphatic dicarboxylic acid are used.

In one embodiment, wherein the monomeric composition of said condensating step has a composition of about 0.1 mol % to about 50 mol % hydroxyl acid, about 1 mol % to about 49.9 mol % diol, about 1 mol % to about 49.9 mol % dicarboxylic acid and about 0.01 mol % to about 10 mol % functionalizing agent.

In one embodiment, the diol is an alkyl-diol having 2 to about 8 carbon atoms, more preferably 2 to about 6 carbon atoms. In one embodiment, the alkyl-diol is butanediol.

In one embodiment, the aliphatic dicarboxylic acid is selected from the group consisting of succinic acid, adipic acid and mixtures thereof.

In one embodiment, the hydroxyacid is an aliphatic hydroxyacid. Exemplary aliphatic hydroxy acids include, for example, lactic acid, glycolic acid, 2-hydroxybutanoic acid, 2-hydroxypentanoic acid, 2-hydroxyhexanoic acid, 2-hydroxyheptanoic acid, 2-hydroxyoctanoic acid, 2-hydroxy-2-methylpropanoic acid, 2-hydroxy-2-methylbutanoic acid, 2-hydroxy-2-ethylbutanoic acid, 2-hydroxy-2-methylpentanoic acid, 2-hydroxy-2-ethylpentanoic acid, 2-hydroxy-2-propylpentanoic acid, 2-hydroxy-2-butylpentanoic acid, 2-hydroxy-2-methylhexanoic acid, 2-hydroxy-2-ethylhexanoic acid, 2-hydroxy-2-propylhexanoic acid, 2-hydroxy-2-butylhexanoic acid, 2-hydroxy-2-pentylhexanoic acid, 2-hydroxy-2-methylheptanoic acid, 2-hydroxy-2-ethylheptanoic acid, 2-hydroxy-2-propylheptanoic acid, 2-hydroxy-2-butylheptanoic acid, 2-hydroxy-2-pentylheptanoic acid, 2-hydroxy-2-hexylheptanoic acid, 2-hydroxy-2-methyloctanoic acid, 2-hydroxy-2-ethyloctanoic acid, 2-hydroxy-2-propyloctanoic acid, 2-hydroxy-2-butyloctanoic acid, 2-hydroxy-2-pentyloctanoic acid, 2-hydroxy-2-hexyloctanoic acid, 2-hydroxy-2-heptyloctanoic acid, 3-hydroxypropanoic acid, 3-hydroxybutanoic acid, 3-hydroxypentanoic acid, 3-hydroxyhexanoic acid, 3-hydroxyheptanoic acid, 3-hydroxyoctanoic acid, 3-hydroxy-3-methylbutanoic acid, 3-hydroxy-3-methylpentanoic acid, 3-hydroxy-3-methylheptanoic acid, 3-hydroxy-3-ethylpentanoic acid, 3-hydroxy-3-methylhexanoic acid, 3-hydroxy-3-ethylhexanoic acid, 3-hydroxy-3-propylhexanoic acid, 3-hydroxy-3-methylheptanoic acid, 3-hydroxy-3-ethylheptanoic acid, 3-hydroxy-3-propylheptanoic acid, 3-hydroxy-3-butylheptanoic acid, 3-hydroxy-3-methyloctanoic acid, 3-hydroxy-3-ethyloctanoic acid, 3-hydroxy-3-propyloctanoic acid, 3-hydroxy-3-butyloctanoic acid, 3-hydroxy-3-pentyloctanoic acid, 4-hydroxybutanoic acid, 4-hydroxypentanoic acid, 4-hydroxyhexanoic acid, 4-hydroxyheptanoic acid, 4-hydroxyoctanoic acid, 4-hydroxy-4-methylpentanoic acid, 4-hydroxy-4-methylhexanoic acid, 4-hydroxy-4-ethylhexanoic acid, 4-hydroxy-4-methylheptanoic acid, 4-hydroxy-4-ethylheptanoic acid, 4-hydroxy-4-propylheptanoic acid, 4-hydroxy-4-methyloctanoic acid, 4-hydroxy-4-ethyloctanoic acid, 4-hydroxy-4-propyloctanoic acid, 4-hydroxy-4-butyloctanoic acid, 5-hydroxypentanoic acid, 5-hydroxyhexanoic acid, 5-hydroxyheptanoic acid, 5-hydroxyoctanoic acid, 5-hydroxy-5-methylhexanoic acid, 5-hydroxy-5-methylheptanoic acid, 5-hydroxy-5-ethylheptanoic acid, 5-hydroxy-5-methyloctanoic acid, 5-hydroxy-5-ethyloctanoic acid, 5-hydroxy-5-propyloctanoic acid, 6-hydroxyhexanoic acid, 6-hydroxyheptanoic acid, 6-hydroxyoctanoic acid, 6-hydroxy-6-methylheptanoic acid, 6-hydroxy-6-methyloctanoic acid, 6-hydroxy-6-ethyloctanoic acid, 7-hydroxyheptanoic acid, 7-hydroxyoctanoic acid, 7-hydroxy-7-methyloctanoic acid, 8-hydroxyoctanoic acid, other aliphatic hydroxycarboxylic acids, mixtures of these acids and oligomers of these acids.

Some aliphatic hydroxy acid and the polymer of the same have optically active carbon in the molecule and are distinguished in the form of a D-isomer, L-isomer and D/L-isomer, respectively. Any of these isomers can be used in the disclosed process. For example, the aliphatic hydroxy acid may be lactic acid which may be either optically active (e.g., D- or L-lactic acid, lactide) or inactive (i.e., D,L-lactide) or a mixture of optical active and inactive forms.

In one embodiment, the hydroxyl acid is lactic acid.

The condensating step may comprise the step of heating said mixture of hydroxy acid, diol, dicarboxylic acid and said functionalizing agent. The heating step may be undertaken in the range from about 100 degree C. to about 260 degree C.

The condensating step may be undertaken for about 5 hours to about 40 hours.

The heating step may be undertaken in an inert atmosphere, such as with nitrogen gas being injected through the mixer of hydroxy acid, diol and dicarboxylic acid.

The condensating step (a) may comprise the step of applying a′ vacuum to said mixer of hydroxy acid, diol and dicarboxylic acid as they reacts with said functionalizing agent.

The vacuum may be applied in the range of about 5 mmHg (˜0.67 KPa) to about 600 mmHg (˜80 KPa).

The condensating step occurs in a reaction zone, such as in a chamber having an agitating means such as a stirrer. The reaction zone consists of a liquid phase in which the hydroxy acid, diol, dicarboxylic acid and functionalizing agent react with each other and a gaseous or volatile phase, in which by-products of the reaction, in particular water, are driven off from the liquid phase. Advantageously, application of the vacuum ensures that the volatile phase is removed from the liquid phase during the condensating step. Removal of the volatile phase which typically contains a significant amount of water produced during the condensation reaction, drives the reaction forward to produce more prepolymer. Accordingly, the condensating step may comprise the step of removing condensed water formed during polycondensation by vacuum and/or nitrogen.

The condensating step may comprise the step of agitating said mixture of hydroxy acid, diol, dicarboxylic acid and functionalizing agent. The agitating may be undertaken with a screw driven extruder which may be undertaken at a speed of about 200 rpm.

The process may comprise the step of providing a catalyst during at least one of said condensating step and said coupling step to increase the rate of reaction of those steps.

The catalyst may be suitable for dehydration.

Exemplary catalysts which can be used in the invention are metals, metal salts, hydroxides and oxides in the group I, II, III, IV and V of the periodic table and include, for example, zinc, tin, aluminum, magnesium, antimony, titanium, zirconium and other metals such as tin oxide, antimony oxide, lead oxide, aluminum oxide, magnesium oxide, titanium oxide and other metal oxides; zinc chloride, stannous chloride, stannic chloride, stannous bromide, stannic bromide, antimony fluoride, magnesium chloride, aluminum chloride and other metal halogenides; sodium hydroxide, potassium hydroxide, calcium hydroxide, magnesium hydroxide, aluminum hydroxide, zinc hydroxide, iron hydroxide, cobalt hydroxide, nickel hydroxide, copper hydroxide, cesium hydroxide, strontium hydroxide, barium hydroxide, lithium hydroxide, zirconium hydroxide and other metal hydroxides; tin sulfate, zinc sulfate, aluminum sulfate and other metal sulfates; magnesium carbonate, zinc carbonate, calcium carbonate and other metal carbonates; tin acetate, stannous octoate, tin lactate, zinc acetate, aluminum acetate, iron lactate and other organic carboxylate metal salts; and tin trifluoromethanesulfonate, tin p-toluenesulfonate and other organic sulfonate metal salts, dibutyltin oxide and other organometal oxides of the above metals, titanium isopropoxide and other metal alkoxides of the above metals, diethylzinc and other alkyl metals of the above metals, and ion exchange resin. The amount of these catalysts are in the range of 0.0001-10% by weight in said liquid phase. In one embodiment the catalyst is selected from the group consisting of tin octoate (tin[II]2-ethylhexanoate), tin chloride (tin[II]2-chloride), tetrabutyl titanate, stannous oxide, titanium isopropoxide.

It is important to note that through the selection of functionalizing agent it is possible to adjust the structure and the properties of polyester copolymer such that the copolymer polyester prepolymer backbone has a plurality of arms comprising functional groups extending from the backbone in a branched structure. During the coupling step, the functional groups extending from the arms of the copolymer polyester prepolymers react with other functional groups extending from the arms of other copolymer polyester prepolymers to thereby form a three-dimensional network of polyester copolymer chains.

Particularly preferred functional groups are compounds which comprise one or more of the following:
(i) any compound having three or more functional groups, where the said functional groups include hydroxyl group, epoxy group, carboxylic acid or ester-forming derivative group thereof or mixtures thereof; and
(ii) unsaturated dicarboxylic acid component selected from the group consisting of dicarboxylic acids, anhydrides thereof and esters thereof with a monohydric alcohol and wherein the ethylenically unsaturated polymeerisable monomer has a —CH═CH₂— group.

Accordingly, in one embodiment, the functionalizing agent is a compound having a functional group selected to form a branch structure polymer on the copolyester backbone after said condensating step. In one embodiment, the functionalizing agent is an unsaturated dicarboxylic acid or anhydride. In another embodiment the functionalizing agent has at least three hydroxyl and/or carboxylic acid groups. In one embodiment, the functionalizing agent is selected from the group consisting of pentaerythritols, glycerols, diglycerols, triglycerols, tetraglycerols, pentaglycerols, and hexaglycerols, glycerol diglycidyl ether and mixtures thereof.

The prepolymer may be in a molten state, and may have a weight average molecular mass of about 5,000 to about 100,000.

Advantageously, the amount of functionalizing agent used in the monomeric mixture to form the prepolymer is in the range of 0.01 mol % to about 10 mol %.

Advantageously, the structure and properties of the said prepolymer can easily be adjusted by the said functionalizing agent.

In some embodiments, particularly those which are batch processes, the condensating step and the coupling step may both occur in the same reaction zone. In continuous processes, the coupling step the condensating step and the coupling step may occur in different parts of the same reaction zone, that is the reaction zone consists of one part in which condensating occurs and another part in which the polymerization occurs. Hence, the monomeric mixture that forms the prepolymer moves from the reaction zone in which condensation occurs and then moves to that part of the reaction zone where polymerization occurs after the coupling step.

The coupling step may comprise the process may comprise the step of adding a coupling agent to the prepolymer undergoing polymerization. The coupling agent may be any agent capable of linking two terminal ends of the prepolymer and/or the arms containing said functional groups. In one embodiment, the coupling agent is an isocyanate coupling agent. In another embodiment, the coupling agent is at least one of isocyanate and diepoxy compounds.

The coupling step may comprise the step of heating, or maintaining the temperature, of said polyester copolymer prepolymer and isocyanate from about 160 degree C. to about 230 degree C.

The coupling step may comprise the step of agitating said polyester copolymer prepolymer and isocyanate at a rotational speed of about 30-300 rpm in a screw driven extruder.

The polyester copolymer produced in the disclosed process may be biodegradable and have a viscosity number in the range from 0.25 to 3.5 dl/g (measured in Chloroform at a concentration of 0.5% by weight of said polyester copolymers at 25° C.) and a melting point in the range from 50° C. to 150° C.

Advantageously, the formed polyester copolymer and the prepolymer has a Notched Izod impact strength of at least about 25 J/m.

In one embodiment, there is provided a melt-processable polymer composition comprising polyhydroxy acid, such as polylactic acid, and at least one of the disclosed prepolymers and higher molecular weight polyester copolymers. Optionally, the melt-processable polymer further comprises conventional additives such as fillers, compatibilizers, plasticizers, stabilizers etc. In this embodiment, the resulting polymer composition has a Notched Izod impact strength at least about 20 J/m. The filler may be talc. The compatibilizer may be a reactive compatibilizer. The compatibilizers may be hexamethylene diisocyanate. The melt-processable polymer composition may have a Notched Izod impact strength at least 25 and a percent elongation of at least 50%.

Notched Izod impact strength can be measured using the method detailed in ASTM D256. Typically, for pure polylactic acid, the Notched izod impact strength is about 12-16 J/m. However, many applications require an enhanced Izod impact strength.

Per-cent elongation at the break point of the produced copolymers produced in the methods taught herein can be measured using the method detailed in ASTM D638-91. Typically, for pure polylactic acid, the percent elongation at break is about 2-6%. However, many applications require an improved percent elongation at break.

### System for Producing Polyester Copolymers

Exemplary, non-limiting embodiments of a reactor and system for implementing the process for producing polyhydroxy acid described above will now be disclosed.

The system comprising a reactor having a reaction zone containing a coupling monomeric mixture of the hydroxyacid, the diol, the dicarboxylic acid and the functionalizing agent. Once the prepolymer is formed, the coupling agent may be added to the reaction zone. The reaction zone is operated under conditions to form high molecular weight polyester copolymer from said coupling monomeric mixture.

The reaction zone may be located in one or more reaction chambers of a reactor. The reactor may comprises a fluid jacket surrounding at least a portion of the outer surface of said enclosed chamber for receiving heated fluid therein in use. In use, said reaction chamber is in fluid communication with a vacuum, said reactor comprises an agitator disposed within said enclosed chamber to agitate said liquid phase therein in use.

The reactor for undertaking the coupling step may be a screw driven extruder. Different screws may be selected to obtain different desired compression ratios. The extruder has an acid-resistant barrel and screw, and the extruder screw has a compression ratio of between approximately 1.5:1 and 3:1. Also, different screw configurations provide different types of mixing. Some examples of screw designs include those with no mixing sections, one mixing section, and two mixing sections.

In one embodiment, the extruder is a twin screw extruder. The twin screw extruder may have an L/D ratio of at least 20, more preferably at least 40. The twin screw extruder may be used for the coupling step or for mixing of the polyester copolymer with polylactic acid. The operating temperature of the twin screw extruder may be about 100 degrees C. to about 220 degrees C., while the pressure may be about 5 mmHg (0.66 kPa) to about 600 mm Hg (80 kPa).

A twin screw mixer may provide advantages of a more homogenous mixing, stable flow, easier feeding, and better control over the process relative to a single screw extruder although a single screw extruder could still be used. This is attributed to the positive pumping effect and lack of compression caused by the twin screw mixer. An exemplary twin screw driven extruder is disclosed in International PCT Published Application No. WO/2003/035349.

### EXAMPLES

Non-limiting examples of the invention will be further described in greater detail by reference to specific embodiments and experimental examples, which should not be construed as in any way limiting the scope of the invention.

### Example 1

A round bottom flask with 500 ml of capacity having an agitator was loaded with 20 g of 88 wt % commercial L-lactic acid (Archer Daniels Midland Co, Decatur, Ill. USA), 185 g 1,4-butanediol (99%, Lancaster), 200 g succinic acid (99%, Alfa Aesar), 1 g glycerol (98%, Sigma-Aldrich) and 0.4 g tetrabutyl titanate (99%, Alfa Aesar) was added as a catalyst. The reaction mixture was heated at 180 degree C. for three hours with an agitation speed of 200 rpm under nitrogen bubbling. Then under reduced pressure 200 mbar for another 3 hours, while maintaining the same agitation speed and temperature. Subsequently, the temperature of the reaction mixture was raised to 210° C., and polymerization was continued under a reduced pressure of 2 mbar for 10 hours to obtain a prepolymer. The total polymerization was around 15 to 25 hours. The reduced viscosity and melting point of the polyester copolymer were 0.52 dl/g and 104° C. respectively.

### Example 2

5 g of hexamethylene diisocyanate (99%, Merck) was then added to the obtained polyester copolymer from example 1. The mixture was agitated in a melt state at 210 degree C. The viscosity rapidly increased and obtained polyester copolymer (A2) with its reduced viscosity 1.43 dl/g and melting point 103 degree C. The product polymer obtained was white color with Mw 134,000.

### Example 3

A round bottom flask with 500 ml of capacity was loaded with 20 g of 88 wt % commercial L-lactic acid (Archer Daniels Midland Co, Decatur, Ill. USA), 190 g 1,4-butanediol (99%, Lancaster), 150 g succinic acid (99%, Alfa Aesar), 50 g adipic acid (99%, Alfa Aesar), 1 g glycerol (98%, Sigma-Aldrich), and 0.4 g tetrabutyl titanate (99%, Alfa Aesar) was added as a catalyst. The reaction mixture was heated at 180 degree C. for three hours with an agitation speed of 200 rpm under nitrogen bubbling. Then under reduced pressure 200 mbar for another 3 hours, while kept the same agitation speed and temperature. Subsequently, the temperature of reaction mixture was raised to 210° C., and polymerization was continued under a reduced pressure of 2 mbar for 15 hours to obtain a polyester copolymer (A3). The total polymerization was around 20 to 30 hours. The reduced viscosity and melting point of the polyester copolymer were 0.68 dl/g and 80 degree C. respectively.

### Example 4

A reactor with 500 ml of capacity was loaded with 25 g 1,4-butanediol (99%, Lancaster), 16 g dimethyl terephthalate (99%, Aldrich), and 0.04 g tetrabutyl titanate (99%, Alfa Aesar) was added as a catalyst. The reaction mixture was heated at 180 degree C. for about five hours with an agitation speed of 200 rpm under nitrogen bubbling, until the approximate theoretical amount of methanol was distilled out. Subsequently, reduced the temperature to 160 degree C., and charged 20 g of 88 wt % commercial L-lactic acid (Archer Daniels Midland Co, Decatur, Ill. USA), 125 g 1,4-butanediol (99%, Lancaster), 160 g succinic acid (99%, Alfa Aesar), 1 g glycerol (98%, Sigma-Aldrich), and 0.04 g tetrabutyl titanate (99%, Alfa Aesar). While stirring the contents of the reaction vessel, nitrogen gas was introduced into the vessel. Under nitrogen atmosphere, the temperature of the mixture was raised to 180 degree C., and reaction was carried out at the temperature for 3 hours, and then under a reduced pressure of 200 mbar for 3 hours. Subsequently, the temperature of the reaction mixture was raised to 210 degree C., and polymerization was continued under a reduced pressure of 2 mbar for 15 hours to obtain a polyester copolymer (A4). The product polymer obtained was white color with reduced viscosity 1.20 dl/g, Mw 10,9000 and melting point 96 degree C. respectively.

### Example 5

The reactor with 12 L of capacity was loaded with 400 g of 88 wt % commercial L-lactic acid (ADM, USA), 4 Kg succinic acid (Megachem), 3700 g 1,4-butanediol (99%, Lancaster), and 10 g glycerin (98%, Sigma-Aldrich), and 8 g tetrabutyl titanate (99%, Alfa Aesar) was added as a catalyst. While stirring the contents of the reaction vessel, nitrogen gas was introduced into the vessel. Under nitrogen atmosphere, the temperature of the mixture was raised to 180 degree C., and reaction was carried out at the temperature for 3 hours, and then under a reduced pressure of 200 mbar for 3 hours. Subsequently, the temperature of the reaction mixture was raised to 210° C., and polymerization was continued under a reduced pressure of 2 mbar for 18 hours to obtain a polyester copolymer (A5). The reduced viscosity and melting point of the polyester were 0.73 dl/g and 103° C. respectively.

### Example 6

Polylactic acid (PLA), A1001 from Hyflux Pte Ltd was compounded with polyester copolymer (A5) at different content with or without a reactive compatibilizing agent, hexamethylene diisocyanate (HMDI). The extruded pellets were dried and then injection molded to produce specimens for tensile and impact testing. Results are presented in Table 1.

TABLE 1

| | | | Elonga- | |
|---|---|---|---|---|
| | | Izod | tion at | Yield |
| | Part | Impact | break | Strength |
| Sample | (wt %) | (J/m) | (%) | (Mpa) |
| PLA | 80 | 16 | 100 | 37 |
| Polyester copolymer (A5) | 20 | | | |
| HMDI | 0.2 | | | |
| PLA | 50 | 20 | 140 | 28.5 |
| Polyester copolymer (A5) | 50 | | | |
| HMDI | 0 | | | |
| PLA | 50 | 24 | 150 | 29.5 |
| Polyester copolymer (A5) | 50 | | | |
| HMDI | 0.5 | | | |
| PLA (comparative example) | 100 | 14 | 4 | 45 |
| Polyester copolymer (A5) | 100 | 26 | 320 | 23.5 |

### Example 7

The reactor with 12 L of capacity was loaded with 400 g of 88 wt % commercial L-lactic acid (ADM, USA), 3200 Kg succinic acid (Megachem), 800 g adipic acid (Invista), 3600 g 1,4-butanediol (99%, Lancaster), and 10 g glycerin (98%, Sigma-Aldrich), and 8 g tetrabutyl titanate (99%, Alfa Aesar) was added as a catalyst. While stirring the contents of the reaction vessel, nitrogen gas was introduced into the vessel. Under nitrogen atmosphere, the temperature of the mixture was raised to 180 degree C., and reaction was carried out at the temperature for 3 hours, and then under a reduced pressure of 200 mbar for 3 hours. Subsequently, the temperature of the reaction mixture was raised to 220° C., and polymerization was continued under a reduced pressure of 2 mbar for 22 hours to obtain a polyester (A7). The reduced viscosity and melting point of the polyester were 0.78 dl/g and 88° C. respectively.

### Example 8

Polylactic acid (PLA), A1001 from Hyflux Pte Ltd was compounded with polyester copolymer (A7) at different content with or without a reactive compatibilizing agent, hexamethylene diisocyanate (HMDI). The extruded pellets were dried and then injection molded to produce specimens for tensile and impact testing. Results are presented in Table 2.

TABLE 2

| | | | Elonga- | |
|---|---|---|---|---|
| | | Izod | tion at | Yield |
| | Part | Impact | break | Strength |
| Sample | (wt %) | (J/m) | (%) | (Mpa) |
| PLA | 80 | 18 | 124 | 29 |
| Polyester copolymer (A7) | 20 | | | |
| HMDI | 0.2 | | | |
| PLA | 50 | 28 | 160 | 22.5 |
| Polyester copolymer (A7) | 50 | | | |
| HMDI | 0 | | | |
| PLA | 50 | 32 | 155 | 25.5 |
| Polyester copolymer (A7) | 50 | | | |
| HMDI | 0.5 | | | |
| PLA | 100 | 14 | 4 | 45 |
| Polyester copolymer (A7) | 100 | 65 | 420 | 15.5 |

Pure PLA thus serves as a good comparative example. As can be seen from the results of Table 2 above, the strength of the biodegradable polyester copolymer is much higher compared at 65 J/m relative to pure PLA of 14 J/m. Hence, the disclosed process provides a useful biodegradable substitute for pure PLA. Furthermore, PLA can be compounded with the polyester copolymer produced in the method disclosed herein so to produce a biodegradable polymer that has increased strength over pure PLA. Furthermore, it can be seen from the results of Table 2 that it is advantageous to use a coupling agent, such as HMDI, to further increase the strength of the produced PLA-polyester copolymer.

### Example 9

A reactor with 500 ml of capacity was loaded with 20 g of 88 wt % commercial L-lactic acid (Archer Daniels Midland Co, Decatur, Ill. USA), 170 g 1,4-butanediol (99%, Lancaster), 200 g succinic acid (99%, Alfa Aesar), 5 g tartaric acid (99%, Alfa Aesar), and 0.4 g tetrabutyl titanate (99%, Alfa Aesar) was added as a catalyst. The reaction mixture was heated at 180 degree C. for three hours with an agitation speed of 200 rpm under nitrogen bubbling. Then under reduced pressure 200 mbar for another 3 hours, while kept the same agitation speed and temperature. Subsequently, the temperature of the reaction mixture was raised to 210 degrees C., and polymerization was continued under a reduced pressure of 2 mbar for 10 hours to obtain a polyester copolymer (A9). The total polymerization was around 20 to 30 hours. The reduced viscosity and melting point of the polyester copolymer were 1.39 dl/g and 103 degree C. respectively.

### Example 10

A reactor with 500 ml of capacity was loaded with 20 g of 88 wt % commercial L-lactic acid (Archer Daniels Midland Co, Decatur, Ill. USA), 185 g 1,4-butanediol (99%, Lancaster), 200 g succinic acid (99%, Alfa Aesar), 0.5 g dipentaerythritol (99%, Sigma-Aldrich), and 0.4 tetrabutyl titanate (99%, Alfa Aesar) was added as a catalyst. The reaction mixture was heated at 180 degree C. for three hours with an agitation speed of 200 rpm under nitrogen bubbling. Then under reduced pressure 200 mbar for another 3 hours, while kept the same agitation speed and temperature. Subsequently, the temperature of the reaction mixture was raised to 210° C., and polymerization was continued under a reduced pressure of 2 mbar for 15 hours to obtain a polyester copolymer (A10). The total polymerization was around 20 to 30 hours. The reduced viscosity and melting point of the polyester copolymer were 1.32 dl/g and 104 degree C. respectively.

### Example 11

A reactor with 500 ml of capacity was loaded with 20 g of 88 wt % commercial L-lactic acid (Archer Daniels Midland Co, Decatur, Ill. USA), 170 g 1,4-butanediol (99%, Lancaster), 200 g succinic acid (99%, Alfa Aesar), 50 g Polycaprolactone triol (Mn=900, 99%, Sigma-Aldrich), and 0.4 g tetrabutyl titanate (99%, Alfa Aesar) was added as a catalyst. The reaction mixture was heated at 180 degree C. for three hours with an agitation speed of 200 rpm under nitrogen bubbling. Then under reduced pressure 200 mbar for another 3 hours, while kept the same agitation speed and temperature. Subsequently, the temperature of the reaction mixture was raised to 210° C., and polymerization was continued under a reduced pressure of 2 mbar for 8 hours to obtain a polyester copolymer (A11). The total polymerization was around 20 to 30 hours. The reduced viscosity and melting point of the polyester copolymer were 1.52 dl/g and 84 degree C. respectively.

### Example 12

A reactor with 12 L of capacity was loaded with 360 g of 88 wt % commercial L-lactic acid (Archer Daniels Midland Co, Decatur, Ill. USA), 3.15 kg 1,4-butanediol (Kimic Chemistry), 3.2 kg succinic acid (Megachem), 800 g adipic acid (Invista), 4.2 g glycerol (98%, Sigma-Aldrich), and 40 g tetrabutyl titanate (99%, Alfa Aesar) was added as a catalyst. The reaction mixture was heated at 180 degree C. for three hours with an agitation speed of 200 rpm under nitrogen bubbling. Then under reduced pressure 200 mbar for another 3 hours, while kept the same agitation speed and temperature. Subsequently, the temperature of the reaction mixture was raised to 220° C., and polymerization was continued under a reduced pressure of 2 mbar for 15 hours to obtain a polyester copolymer (A12). The total polymerization was around 20 to 30 hours. The reduced viscosity and melting point of the polyester copolymer were 0.88 dl/g and 84 degree C. respectively.

### Example 13

60 g of hexamethylene diisocyanate (99%, Merck) was then added to the obtained polyester copolymer from example 12. The mixture was agitated in a melt state at 200 degree C. The viscosity rapidly increased and obtained polyester copolymer (A13) was lightly yellow color with its reduced viscosity was 1.58 dl/g and Mw was 118,000, but gelation did not occur. And the obtained polyester copolymer (A13) had a melting point 83 degree C. The MFR of the obtained polyester copolymer (A13) by ASTM D 1238 at 190 degree C. was 2.5 g/10 min. The obtained polyester copolymer (A13) was dried and then injection molded to produce specimens for tensile and impact testing. Results are presented in Table 3.

TABLE 3

| | | Notched | Elonga- | |
|---|---|---|---|---|
| | | Izod | tion at | Yield |
| | Part | Impact | break | Strength |
| Sample | (wt %) | (J/m) | (%) | (Mpa) |
| Polyester copolymer (A13) | 100 | Not | 620 | 29.5 |
| | | break | | |
| | | (N.B.) | | |

### Applications

There is disclosed polyester copolymers that in one embodiment, are biodegradable. Advantageously, the polyester copolymers have a higher strength relative to at least some other biodegradable polymers, such as polylactic acid. More advantageously, the polyester copolymers disclosed herein may be used as a modifier to increase the strength of biodegradable polylactic acid materials.

Accordingly, due to the increased strength properties of the disclosed polyester copolymers, allows these materials may be used by themselves, or in conjunction with polylactic acid, to be used in engineering plastics. They may also be woven into fibers using, for example, conventional melt-spinning processes. Hence the disclosed polyester copolymers may be used in various applications such as household and industrial wipes, diapers, feminine hygiene products, disposable garments, and UV resistant fabrics. Furthermore, because some of the disclosed polyester copolymers are bioasborable, they and can be assimilated by a biological system and therefore could be used for implants in bone or soft tissue and for resorbable sutures.

Advantageously, the disclosed system and process are relatively simple to operate and maintain.

Advantageously, the disclosed system and process do not produce any environmentally harmful by-products.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A process for producing a polyester copolymer, the process comprising the steps of:
condensating a hydroxyacid, a diol, a dicarboxylic acid and a functionalizing agent selected to form a prepolymer having a polyester copolymer backbone with arms comprising cross-linkable groups extending therefrom; and
coupling said prepolymer in the presence of a coupling agent to cross link the arms of plural prepolymer backbones and thereby form said polyester copolymer comprising said plural straight chain polyester copolymers coupled to each other by said cross-linked arms.

2. A process as claimed in claim 1, wherein said diol is an aliphatic diol, and said dicarboxylic acid is an aliphatic dicarboxylic.

3. A process as claimed in claim 1, wherein said hydroxyacid is lactic acid.

4. A process as claimed in claim 1, wherein the prepolymers have a molecular weight in the range of less than about 100,000.

5. A process as claimed in claim 1, wherein the formed polyester copolymer has a molecular weight in the range of more than about 100,000.

6. A process as claimed in claim 2, wherein the monomeric composition of said condensating step has about 0.1 mol % to about 50 mol % hydroxyl acid.

7. A process as claimed in claim 2, wherein the monomeric composition of said condensating step has about 1 mol % to about 49.9 mol % aliphatic diol.

8. A process as claimed in claim 2, wherein the monomeric composition of said condensating step has about 1 mol % to about 49.9 mol % aliphatic dicarboxylic acid

9. A process as claimed in claim 2, wherein the monomeric composition of said condensating step has about 0.01 mol % to about 10 mol % functionalizing agent.

10. A process as claimed in claim 2, wherein the aliphatic diol is an alkyl-diol having 2 to about 8 carbon atoms.

11. A process as claimed in claim 2, wherein the aliphatic dicarboxylic acid is selected from the group consisting of succinic acid, adipic acid and mixtures thereof.

12. A process as claimed in claim 1, comprising the step of selecting said functionalizing agent such that the copolymer polyester prepolymer backbone has a plurality of arms comprising functional groups extending from the backbone in a branched structure.

13. A process as claimed in claim 1, wherein the compound of said functional agent are any one or more of the following:
I) any compound having three or more functional groups, where the said functional groups include hydroxyl group, epoxy group, carboxylic acid or ester-forming derivative group thereof or mixtures thereof;
II) unsaturated dicarboxylic acid component selected from the group consisting of dicarboxylic acids, anhydrides thereof and esters thereof with a monohydric alcohol and wherein the ethylenically unsaturated polymeerisable monomer has a —CH═CH₂— group.

14. A process as claimed in claim 1, wherein the coupling agent comprises an isocyanate compound.

15. A process for producing a copolymer of polyhydroxy acid and polyester, the process comprising the steps of:
mixing polyhydroxy acid and a reactive compatibilizer with at least one of:
I) a prepolymer formed from a condensated reaction of a hydroxy acid, a diol, a dicarboxylic acid and a functionalizing agent selected to form a polyester copolymer backbone with arms comprising cross-linkable groups extending therefrom; and
II) a copolymer polyester formed from coupling of said prepolymer (I) in the presence of a coupling agent to cross link the arms of plural prepolymer backbones and thereby form said polyester copolymer.

16. A process as claimed in claim 15, wherein said polyhydroxy acid has a high molecular weight.

17. A process as claimed in claim 15, wherein said polyhydroxy acid is polylactic acid.

18. A process as claimed in claim 15, wherein said diol is an aliphatic diol and said dicarboxylic acid is an aliphatic dicarboxylic acid.

19. A process as claimed in claim 15, comprising the step of selecting said functionalizing agent such that the copolymer polyester prepolymer backbone has a plurality of arms comprising functional groups extending from the backbone in a branched structure.

20. A melt processable composition comprising:
a first phase comprising a polyhydroxy acid; and
a second phase comprising at least one of:
i) a prepolymer formed by condensating a hydroxyacid, a diol, a dicarboxylic acid and a functionalizing agent selected to form a prepolymer having a polyester copolymer backbone with arms comprising cross-linkable groups extending therefrom; and
a polyester copolymer made in claim 1.

21.-25. (canceled)
